(19) United States
(12) Patent Application Publication
(10) Pub. No.: US 2016/0288300 A1
(43) Pub. Date: Oct. 6, 2016

(54) Combination wrench

(71) Applicant: Kuo Lung Chen, Nantou (TW)

(72) Inventor: Kuo Lung Chen, Nantou (TW)

(21) Appl. No.: 15/183,782

(22) Filed: Jun. 16, 2016

(51) Int. Cl. B25B 13/56; B25B 13/08; B25B 13/06; B25B 13/04

(52) U.S. Cl. CPC B25B 13/56; B25B 13/04; B25B 13/08; B25B 13/065

(57) ABSTRACT

A combination wrench includes a handle having an open end and a box end. At least one of the open and box ends includes two opposite interior surfaces each including a first tilted surface; a first tooth including a first surface, a second tilted surface, and a first shoulder between the first tilted surface and the first surface; and a second tooth including a second surface, a third tilted surface, and a second shoulder between the second surface and the second tilted surface. Even the damaged head of a bolt or a nut can be gripped by the teeth.

### BACKGROUND OF THE INVENTION

1. Field of the Invention

The invention relates to combination wrenches and more particularly to a combination wrench having an improved tooth arrangement at either end or both ends thereof.

2. Description of Related Art

There is a commercially available wrench capable of retaining nuts and bolts for use in areas to which access is difficult. The wrench includes a retaining arrangement for holding a nut or bolt in place. The retaining arrangement is slidingly mounted so that it may adapt itself to the particular face or side of the wrench being used.

While the wrench enjoys its success in the market, continuing improvements in the exploitation of combination wrench of this type are constantly being sought.

### SUMMARY OF THE INVENTION

It is therefore one object of the invention to provide a combination wrench comprising a handle comprising an open end and a box end; wherein at least one of the open and box ends comprises two opposite interior surfaces each including a first tilted surface; a first tooth including a first surface, a second tilted surface, and a first shoulder between the first tilted surface and the first surface; and a second tooth including a second surface, a third tilted surface, and a second shoulder between the second surface and the second tilted surface; wherein the first tilted surface is at an angle of about 3-10 degrees with respect to a longitudinal axis of the handle; wherein the first surface is at an angle of about 3-6 degrees with respect to the longitudinal axis of the handle; wherein the second surface is at an angle of about 2-5 degrees with respect to the longitudinal axis of the handle; wherein the first shoulder is at an angle of about 90 degrees with respect to the longitudinal axis of the handle; and wherein the second shoulder is at an angle of about 90 degrees with respect to the longitudinal axis of the handle.

The above and other objects, features and advantages of the invention will become apparent from the following detailed description taken with the accompanying drawings.

### BRIEF DESCRIPTION OF THE DRAWINGS

FIG. 1 is a perspective view of a combination wrench according to the invention;

FIG. 2 is a plan view of one portion of the open end of the combination wrench;

FIG. 3 is a plan view of the open end of the combination wrench;

FIG. 4 is a view similar to FIG. 3 showing the hexagonal head of a bolt being gripped by the teeth of the open end of the combination wrench;

FIG. 5 is a view similar to FIG. 4 showing the damaged hexagonal head of another bolt being gripped by the teeth of the open end of the combination wrench;

FIG. 6 is a plan view of the box end of the combination wrench;

FIG. 7 is a plan view of the socket and a portion of the handle of a flex-head socket wrench, the socket incorporating the tooth arrangement of the invention; and

FIG. 8 is a perspective view of a socket incorporating the tooth arrangement of the invention.

### DETAILED DESCRIPTION OF THE INVENTION

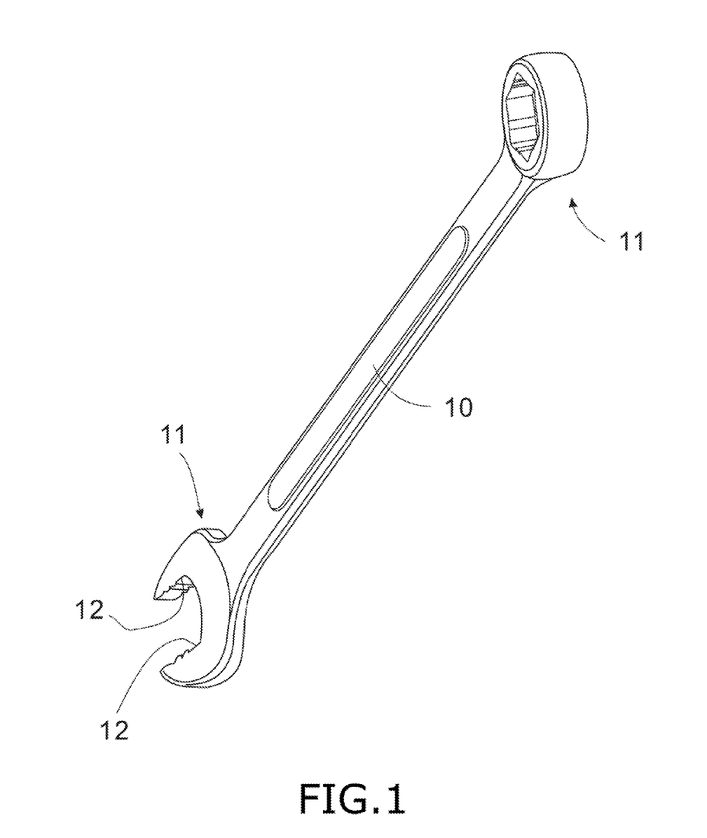

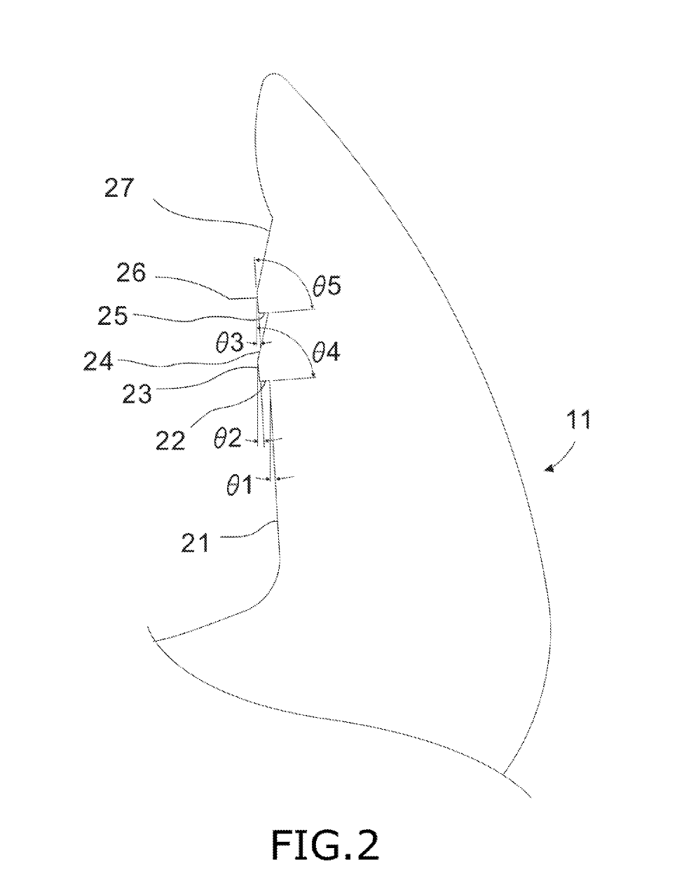

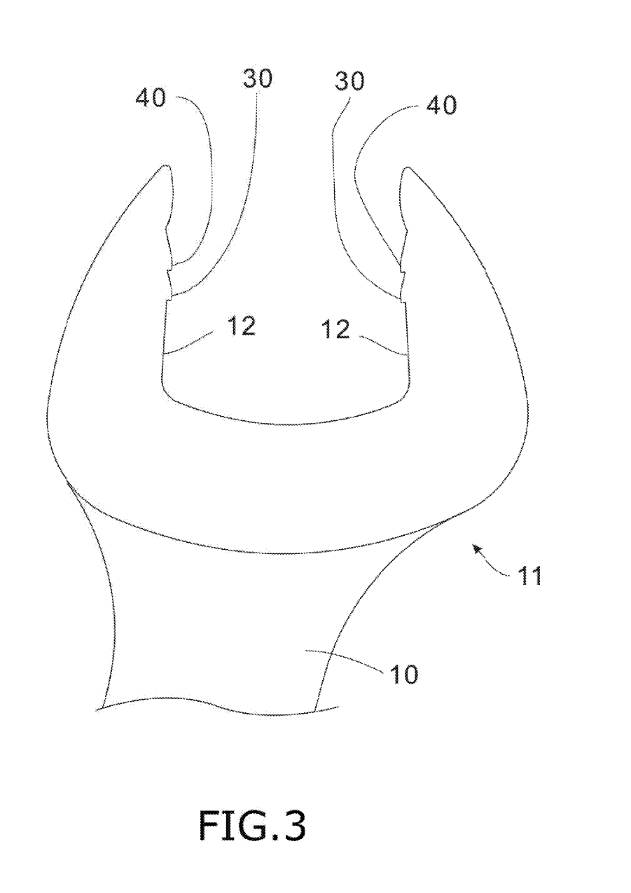

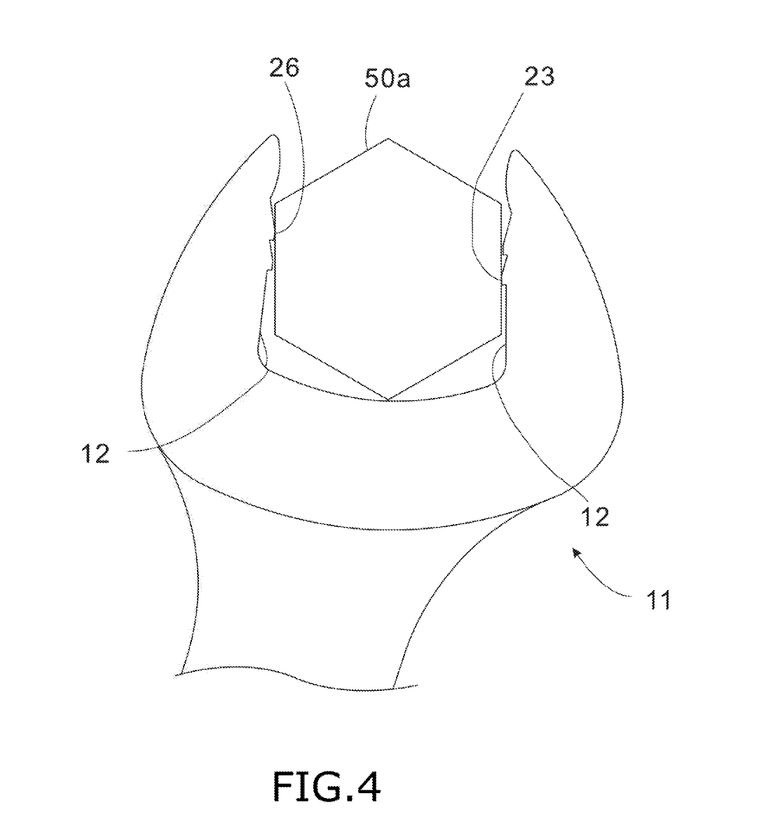

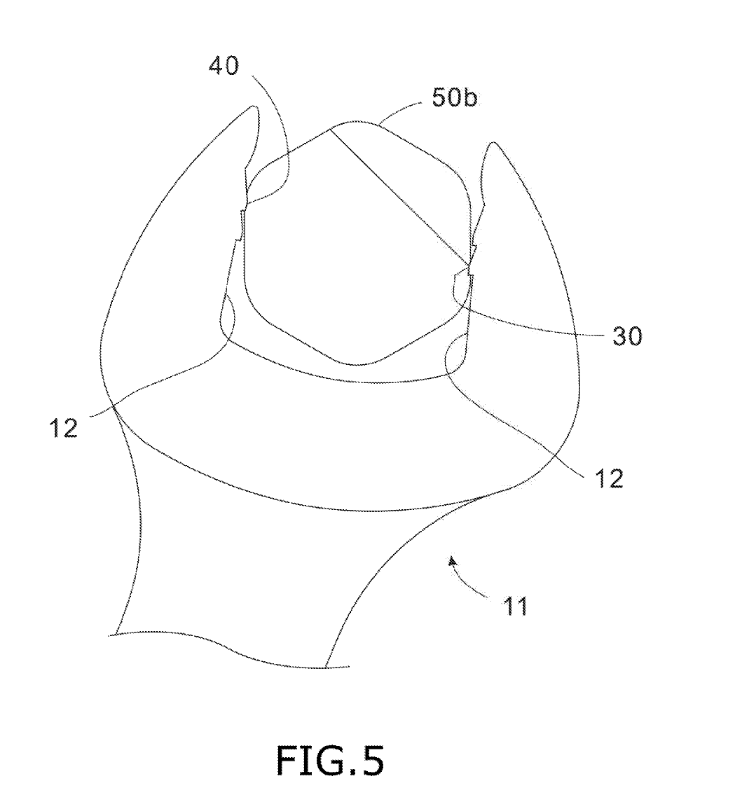

Referring to FIGS. 1 to 6, a combination wrench in accordance with the invention comprises the following components as discussed in detail below.

A handle 10 having two ends 11 are provided in which one end 11 is an open end and the other end 11 is a box end. Two opposite interior surfaces 12 are provided on the open end 11. The interior surface 12 includes a first tilted surface 21 distal an opening, a first tooth 30, and a second tooth 40 proximate the opening. The first tooth 30 includes a first surface 23 and a second tilted surface 24. A first shoulder 22 is formed between the first tilted surface 21 and the first surface 23. The second tooth 40 includes a second surface 26 and a third tilted surface 27. A second shoulder 25 is formed between the second surface 26 and the second tilted surface 24.

The first tilted surface 21 is at an angle θ1 of about 3-10 degrees with respect to a longitudinal axis of the handle 10. The first surface 23 is at an angle θ2 of about 3-6 degrees with respect to the longitudinal axis of the handle 10. The second surface 26 is at an angle θ3 of about 2-5 degrees with respect to the longitudinal axis of the handle 10. The first shoulder 22 is at an angle θ4 of about 90 degrees with respect to the longitudinal axis of the handle 10. The second shoulder 25 is at an angle θ5 of about 90 degrees with respect to the longitudinal axis of the handle 10.

The hexagonal head 50a of a bolt can be gripped by the teeth of the open end. Alternatively, the damaged hexagonal head 50b of another bolt can be gripped by the teeth of the open end.

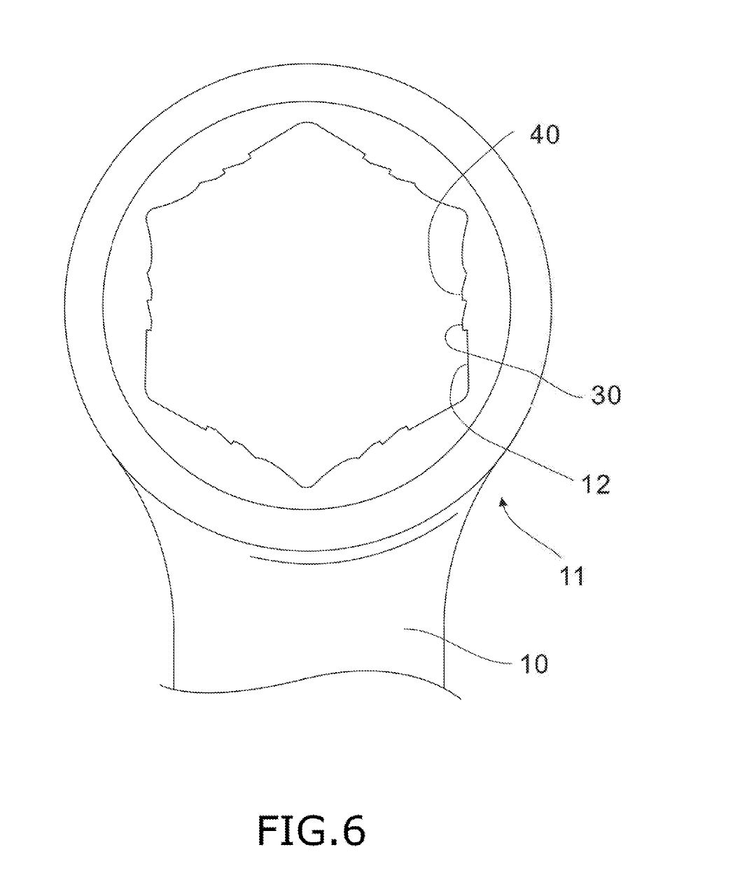

The box end 11 of the combination wrench incorporating the tooth arrangement is shown in FIG. 6.

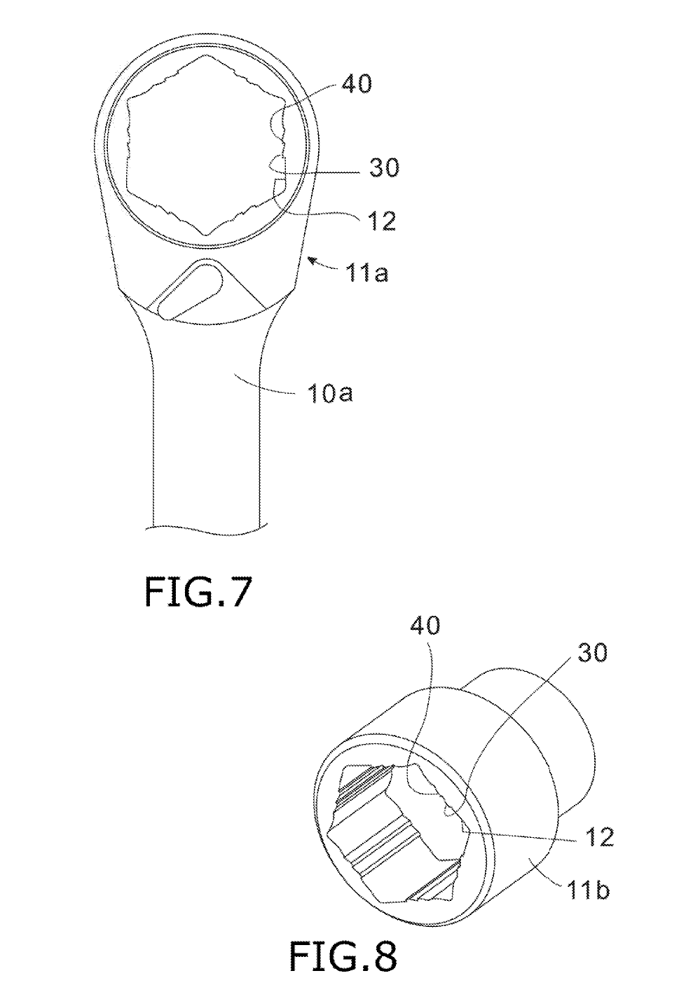

Referring to FIG. 7, a socket 11a and a portion of a handle 10a of a flex-head socket wrench incorporating the tooth arrangement of the invention is shown.

Referring to FIG. 8, a socket 11b incorporating the tooth arrangement of the invention is shown.

While the invention has been described in terms of preferred embodiments, those skilled in the art will recognize that the invention can be practiced with modifications within the spirit and scope of the appended claims.

What is claimed is:

1. A combination wrench comprising:
a handle having an open end and a box end;
wherein at least one of the open and box ends comprises two opposite interior surfaces each including a first tilted surface; a first tooth including a first surface, a second tilted surface, and a first shoulder between the first tilted surface and the first surface; and a second tooth including a second surface, a third tilted surface, and a second shoulder between the second surface and the second tilted surface;
wherein the first tilted surface is at an angle of about 3-10 degrees with respect to a longitudinal axis of the handle;
wherein the first surface is at an angle of about 3-6 degrees with respect to the longitudinal axis of the handle;
wherein the second surface is at an angle of about 2-5 degrees with respect to the longitudinal axis of the handle;
wherein the first shoulder is at an angle of about 90 degrees with respect to the longitudinal axis of the handle; and
wherein the second shoulder is at an angle of about 90 degrees with respect to the longitudinal axis of the handle.
